(19) United States
(12) Patent Application Publication
(10) Pub. No.: US 2004/0202840 A1
(43) Pub. Date: Oct. 14, 2004

(54) Method of printing retroreflective sheeting and articles

(75) Inventors: Thanh-Huong T. Do, Oakdale, MN (US); Thomas F. Look, Ham Lake, MN (US); Bruce D. Orensteen, St. Paul, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/288,721

(22) Filed: Nov. 5, 2002

Related U.S. Application Data
(60) Provisional application No. 60/332,885, filed on Nov. 5, 2001.

(51) Int. Cl. B32B 3/00; B41M 5/00

(52) U.S. Cl. 428/195.1; 156/277; 156/234; 347/105; 428/336; 428/500; 428/423.1; 428/325

(57) ABSTRACT

The present invention relates to a method of printing retroreflective sheeting and corresponding articles. The invention is useful for improving the print quality, particularly for contact printing methods such as thermal mass transfer printing.

### RELATED APPLICATION

This application claims priority to patent application Serial No. 60/332885 filed Nov. 5, 2001.

### FIELD OF THE INVENTION

The present invention relates to a method of printing retroreflective sheeting and corresponding articles. The invention is useful for improving the print quality, particularly for relatively thin ink-receptive layers that are imaged with contact printing methods such as thermal mass transfer printing.

### BACKGROUND OF THE INVENTION

WO 94/19710 relates to thermal print receptive and frangible retroreflective polymeric sheetings. The polymeric sheeting material comprises a core sheet and a thermally print receptive surface on the core sheet. The thermally print receptive surface may be formed from compositions comprising a polyurethane dispersion. FIG. 1, as also described in WO 94/19710 shows a known retroreflective sheeting 12 comprising removable protective liner 14 at the bottom most side, retroreflective layer 16, pressure sensitive adhesive layer 26, polyethylene terephthalate (PET) layer 18 with a thickness of about 25 microns and colorant/binder receptive print layer 20. Retroreflective layer 16 comprises a monolayer of glass microspheres 30 embedded in a layer of polyvinyl butyral binder 34 with underlying reflective layer 32 and pressure sensitive adhesive layer 36. Layer 20 is directly thermally print receptive with a resin-based indicia and is formed from a composition comprising PET and a vinylidene/acrylonitrile copolymer. As described in WO 94/19710, this sheeting material 12 is manufactured for use as an indoor product, commercially available from 3M, St. Paul, Minn. under the trade designation “ScotchMark brand label stock 3929”.

### SUMMARY OF THE INVENTION

The present inventor has found a method of improving the print quality of contact print methods such as thermal mass transfer printing. In one embodiment, the invention relates to a method of printing a retroreflective substrate comprising providing a substrate wherein the substrate comprises a retroreflective layer, an adhesive layer disposed on the retroreflective layer, and an ink-receptive layer disposed on the adhesive layer; and printing the ink-receptive layer. The ink-receptive layer has a thickness of less than 1 mil (25 microns) and/or is comprised of an acrylic-based or urethane-based polymer. The thickness of the ink-receptive layer is preferably less than 0.8 mils (20 microns), more preferably less than 0.5 mils (12.5 microns), even more preferably less than 0.3 mils (7.5 microns), and most preferably about 0.1 mils (2.5 microns),

In another embodiment, the substrate comprises a retroreflective layer, an adhesive layer disposed above the retroreflective layer, and an ink-receptive layer disposed above the adhesive layer; wherein the print quality is improved.

In each of these methods the substrate is preferably printed with a contact printing method such as thermal mass transfer.

In other embodiments, the invention relates to retroreflective substrates (i.e. articles) that exhibit good print quality when imaged with contact printing methods such as thermal mass printing, as well as the imaged sheeting.

In other embodiments, the invention relates to methods of making such imageable or imaged retroreflective substrates.

In each of these embodiments, the print quality is preferably improved by at least one integer, and more preferably two integers, according to the Print Quality Rating Scale. Further, the adhesive preferably permanently bonds the retroreflective layer to the ink-receptive layer. The adhesive preferably has an elastic modulus of less than 0.3 GPa, more preferably less than 0.2 GPa, and even more preferably less than 0.1 GPa. The retroreflective layer may comprise a plurality of cube corner retroreflective elements or a binder layer having glass microspheres.

### DESCRIPTION OF THE DRAWINGS

FIG. 1 is a schematic cross-sectional view of a known retroreflective sheeting material.

FIG. 2 is a schematic cross-sectional view of thermal mass printable retroreflective sheeting material in accordance with the present invention.

FIG. 3 is a schematic cross-sectional view of imaged retroreflective sheeting material in accordance with the present invention.

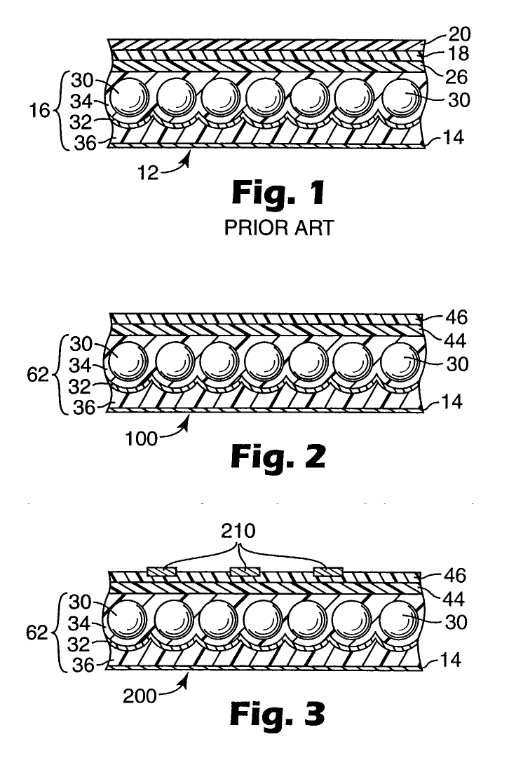

### DESCRIPTION OF THE INVENTION

The methods of the present invention generally relate to imaging retroreflective sheeting and in particular methods of imaging retroreflective sheeting with imaging techniques that employ contact between the printing device (e.g. print head) and the sheeting, such as thermal mass transfer printing. The method of the invention entails providing a substrate comprising a retroreflective layer, an ink-receptive layer on the outermost viewing surface, and an adhesive layer disposed between the retroreflective layer and ink-receptive layer; and printing the ink-receptive layer.

In one embodiment, the invention relates to a thermal mass print receptive retroreflective substrate comprising a retroreflective layer, an ink-receptive layer on the outermost surface, and an adhesive layer disposed therebetween. An exemplary thermal mass print receptive retroreflective sheeting is depicted in FIG. 2. Sheeting 100 comprises retroreflective layer 62 that comprises a monolayer of glass microspheres 30 embedded in a layer of polyvinyl butyral binder 34 with underlying reflective layer 32. The viewing surface of the sheeting comprises adhesive layer 44 disposed between the retroreflective layer and ink-receptive layer 46. Adhesive layer 44 permanently bonds the adjacent layers and thus is present in the finished imaged retroreflective article. Although, the sheeting may further comprise additional layers such as primers, in preferred embodiments adhesive layer 44 permanently bonds retroreflective layer 62 to ink-receptive layer 46. Typically, the sheeting comprises a pressure sensitive adhesive layer 36 on the non-viewing surface that is protected by a removable liner 14. During use, the liner 14 is removed and the sheeting is adhered by means of adhesive 36 to a target substrate, such as a sign backing, license plate backing, billboard, automobile, truck, airplane, building, awning, window, floor, etc.

The method of the invention is particularly advantageous for imaging retroreflective sheeting wherein the absence of the underlying adhesive layer results in the sheeting exhibiting poor print quality. Poor print quality refers to the physical property of exhibiting less than a “3” according to the print quality rating scale, described in further detail in the examples. Poor print quality can arise when the ink-receptive layer is very thin. Accordingly, the present invention is advantageous for embodiments wherein the ink-receptive layer is less than 1 mil (25 microns). The invention is more advantageous for ink-receptive layers having a thickness of less than about 0.8 mils (20 microns), even more advantageous for thickness of less than 0.50 mils (12.5) and particularly advantageous for ink-receptive layers having a thickness of less than 0.3 mils (7.5 microns).

Regardless of thickness of the ink-receptive layer, poor print quality can also be a problem when the ink-receptive layer is comprised of a material having low conformance (i.e. high elastic modulus) such as in the case of ink-receptive layers based on crosslinked urethane-based polymeric materials and acrylic polymers.

The ink-receptive layer and adhesive for use in the invention are sufficiently transparent such that the presence thereof does not detract from the intended retroreflective properties of the sheeting. A variety of compositions suitable for use as the ink-receptive layers or the adhesive layer are known in the art. Preferred ink-receptive coatings include emulsions and dispersions of vinyl-based polymers, polyurethane polymer(s), acrylic polymer(s), and mixtures thereof. An exemplary ink-receptive coating includes a polyurethane dispersion, commercially available from Avecia, Wilmington, Mass., under the trade designation “Neorez R-960” that has been admixed with a crosslinker, such as an aziridine crosslinker, also available from Avecia, under the trade designation “CX-100”. Alternatively, the ink-receptive layer may be provided as a preformed film.

An exemplary imaged article is depicted in FIG. 3 wherein sheeting 200 comprises indicia 210 on the outermost viewing surface of ink receptive layer 46. Optionally, a topcoat or additional film may be disposed on the viewing surface, sandwiching the print between the ink-receptive layer and optional topcoat or film to increase the durability of the retroreflective article.

The ink-receptive layer can be printed with a variety of apparatus to produce graphic images, alphanumeric characters, bar codes and the like. Although the method and articles of the invention may be suitable for use with non-contact printing methods, the invention is particularly advantageous for methods that employ contact between the ink-receptive layer and the printing device (e.g. print head) such as the case in thermal mass transfer printing. Contact printing methods include gravure, off-set, flexographic, lithographic, electrographic (including electrostatic), electrophotographic (including laser printing and xerography). Thermal printing is a term broadly used to describe several different families of technology for making an image on a substrate. Those technologies include hot stamping, direct thermal printing, dye diffusion printing and thermal mass transfer printing.

Hot stamping is a mechanical printing system in which a pattern is stamped or embossed through a ribbon onto a substrate, such as disclosed in U.S. Pat. No. 4,992,129 (Sasaki et al.). The pattern is imprinted onto the substrate by the application of heat and pressure to the pattern. A colored material on the ribbon, such as a dye or ink, is thereby transferred to the substrate where the pattern has been applied. The substrate can be preheated prior to imprinting the pattern on the substrate. Since the stamp pattern is fixed, hot stamping cannot easily be used to apply variable indicia or images on the substrate. Consequently, hot stamping is typically not useful for printing variable information, such as printing sheets used to make license plates.

Direct thermal printing was commonly used in older style facsimile machines. Those systems required a special substrate that includes a colorant so that localized heat can change the color of the paper in the specified location. In operation, the substrate is conveyed past an arrangement of tiny individual heating elements, or pixels, that selectively heat (or not heat) the substrate. Wherever the pixels heat the substrate, the substrate changes color. By coordinating the heating action of the pixels, images such as letters and numbers can form on the substrate. However, the substrate can change color unintentionally such as when exposed to light, heat or mechanical forces.

Dye diffusion thermal transfer involves the transport of dye by the physical process of diffusion from a dye donor layer into a dye receiving substrate. Typically, the surface of the film to be printed further comprises a dye receptive layer in order to promote such diffusion. Similar to direct thermal printing, the ribbon containing the dye and the substrate is conveyed past an arrangement of heating elements (pixels) that selectively heat the ribbon. Wherever the pixels heat the ribbon, solid dye liquefies and transfers to the substrate via diffusion. Some known dyes chemically interact with the substrate after being transferred by dye diffusion. Color formation in the substrate may depend on a chemical reaction. Consequently, the color density may not fully develop if the thermal energy (the temperature attained or the time elapsed) is too low. Thus, color development using dye diffusion is often augmented by a post-printing step such as thermal fusing. Alternatively, U.S. Pat. No. 5,553,951 (Simpson et al.) discloses one or more upstream or downstream temperature controlled rollers to provide greater temperature control of the substrate during the printing process.

Thermal mass transfer printing, also known as thermal transfer printing, non-impact printing, thermal graphic printing and thermography, has become popular and commercially successful for forming characters on a substrate. Like hot stamping, heat and pressure are used to transfer an image from a ribbon onto a substrate. Like direct thermal printing and dye diffusion printing, pixel heaters selectively heat the ribbon to transfer the colorant to the substrate. However, the colorant on the ribbon used for thermal mass transfer printing comprises a polymeric binder having a wax base, resin base or mixture thereof typically containing pigments and/or dyes. During printing, the ribbon is positioned between the print head and the exposed surface of the polymer film. The print head contacts the thermal mass transfer ribbon and the pixel heater heats the ribbon such that the print head transfers the colorant from the ribbon to the film as the film passes through the thermal mass transfer printer.

An example of a representative thermal mass transfer printer is manufactured by Zebra Technologies Corporation, Vernon Hills, Ill. under the trade designation “Model L170XI”. Suitable ribbons for use in thermal mass printing are available from various suppliers including International Imaging Materials, Inc., Amherst, N.Y. and Dai Nippon Corporation, Concord, N.C. These thermal mass transfer ribbons typically include a backing of polyester about 6 micrometer thick and a layer of colorant about 0.5 micrometers to about 6.0 micrometers thick. Additional information relating to conventional thermal mass transfer printing techniques is set forth in U.S. Pat. No. 5,818,492 (Look) and U.S. Pat. No. 4,847,237 (Vanderzanden).

The retroreflective layer is commonly provided as retroreflective sheeting. The two most common types of retroreflective sheeting suitable for use are microsphere-based sheeting and cube corner-based sheeting. Microsphere sheeting, sometimes referred to as “beaded sheeting,” is well known to the art and includes a multitude of microspheres typically at least partially embedded in a binder layer, and associated specular or diffuse reflecting materials (such as metallic vapor or sputter coatings, metal flakes, or pigment particles). Illustrative examples of microsphere-based sheeting are disclosed in U.S. Pat. No. 4,025,159 (McGrath); U.S. Pat. No. 4,983,436 (Bailey); U.S. Pat. No. 5,064,272 (Bailey); U.S. Pat. No. 5,066,098 (Kult); U.S. Pat. No. 5,069,964 (Tolliver); and U.S. Pat. No. 5,262,225 (Wilson).

A preferred retroreflective core comprises glass microspheres that provides a low level of retroreflectivity, the retroreflectivity being substantially enhanced upon application of the ink-receptive topcoat or topfilm that completes the optics. The glass microspheres are dispersed throughout the binder layer and are present substantially as a monolayer dispersed in the binder layer with an underlying specular reflective layer spaced from the microspheres by the transparent binder material. Suitable binder layer materials include polyvinyl butyral, aliphatic polyurethane and polyurethane extended polyester (e.g., described at column 15, lines 30-35 of U.S. Pat. No. 5,882,771). The specular reflective layer may be a vapor deposited aluminum layer.

Cube corner sheeting, sometimes referred to as prismatic, microprismatic, or triple mirror reflector sheetings, typically includes a multitude of cube corner elements to retroreflect incident light. Cube corner retroreflectors typically include a sheet having a generally planar front surface and an array of cube corner elements protruding from the back surface. Cube corner reflecting elements include generally trihedral structures that have three approximately mutually perpendicular lateral faces meeting in a single corner—a cube corner. In use, the retroreflector is arranged with the front surface disposed generally toward the anticipated location of intended observers and the light source. Light incident on the front surface enters the sheet and passes through the body of the sheet to be reflected by each of the three faces of the elements, so as to exit the front surface in a direction substantially toward the light source. In the case of total internal reflection, the air interface must remain free of dirt, water and adhesive and therefore is enclosed by a sealing film. The light rays are typically reflected at the lateral faces due to total internal reflection, or by reflective coatings, as previously described, on the back side of the lateral faces. Preferred polymers for cube corner sheeting include poly(carbonate), poly(methylmethacrylate), poly(ethyleneterephthalate), aliphatic polyurethanes, as well as ethylene copolymers and ionomers thereof. Cube corner sheeting may be prepared by casting directly onto a film, such as described in U.S. Pat. No. 5,691,846 (Benson) incorporated herein by reference. Preferred polymers for radiation cured cube corners include cross linked acrylates such as multifunctional acrylates or epoxies and acrylated urethanes blended with mono-and multifunctional monomers. Further, cube corners such as those previously described may be cast on to plasticized polyvinyl chloride film for more flexible cast cube corner sheeting. These polymers are preferred for one or more reasons including thermal stability, environmental stability, clarity, excellent release from the tooling or mold, and capability of receiving a reflective coating.

In embodiments wherein the sheeting is likely to be exposed to moisture, the cube corner retroreflective elements are preferably encapsulated with a seal film. In instances wherein cube corner sheeting is employed as the retroreflective layer, a backing layer may be present for the purpose of opacifying the laminate or article, improving the scratch and gouge resistance thereof, and/or eliminating the blocking tendencies of the seal film. Illustrative examples of cube corner-based retroreflective sheeting are disclosed in U.S. Pat. No. 5,138,488 (Szczech); U.S. Pat. No. 5,387,458 (Pavelka); U.S. Pat. No. 5,450,235 (Smith); U.S. Pat. No. 5,605,761 (Burns); U.S. Pat. No. 5,614,286 (Bacon) and U.S. Pat. No. 5,691,846 (Benson, Jr.).

The coefficient of retroreflection of the retroreflective article varies depending on the desired properties of the finished article. In general, however, the retroreflective article typically has a coefficient of retroreflection ranging from about 5 to about 1500 candelas per lux per square meter at 0.2 degree observation angle and −4 degree entrance angle, as measured according to ASTM E-810 test method for coefficient of retroreflection of retroreflective sheeting. The coefficient of retroreflection is preferably at least 10, more preferably at least 15, and even more preferably at least 20 candelas per lux per square meter.

As used herein “adhesive layer” refers to a layer that permanently bonds the adjacent layers in contact with the adhesive layer to each other (e.g. permanently bonds the retroreflective layer to the ink-receptive coating or film). By permanently bonds it is meant that the ink-receptive layer can not be separated from the retroreflective layer without damaging the ink-receptive layer. The adhesive layer may be derived from a water-based adhesive composition, a solvent-based adhesive composition, as well as 100% solids adhesive composition such as a hot melt adhesive. Pressure-sensitive adhesives such as acrylic-based and rubber-based pressure sensitive adhesive compositions are preferred.

The adhesive is conformable at ambient temperature as well as at the printing temperature. A preferred way of characterizing the conformability of the adhesive is to measure the elastic modulus, such method being further described in the forthcoming examples. In general, the adhesive has an elastic modulus of less than about 0.5 GPa at ambient temperature. The elastic modulus, is preferably less than 0.3 GPa, more preferably less than 0.2 GPa, and most preferably less than about 0.1 GPa. The elastic modulus is surmised to be at least about 0.005 GPa, and more preferably at least about 0.008 GPa. For printing methods that involve heat, the adhesive is preferably conformable at the print head temperature. For a universal removable adhesive layer that is suitable for ambient temperature printing as well as thermal printing, the adhesive preferably has a substantially flat elastic modulus curve as a function of temperature such that the elastic modulus is within the specified range at temperatures ranging from about 25° C. up to the maximum print heat temperature (e.g. 300° F.).

The thickness of the adhesive layer can vary, provided that the adhesive layer contributes the desired conformability. Typically, the adhesive coating weight ranges from about 0.2 mils (2.5 microns) to 10 mils (250 microns). It is preferred that the thickness of the adhesive layer is greater than the thickness of the ink-receptive layer. Accordingly, the thickness of the adhesive layer is preferably at least about 0.3 mils (4 microns). Further, the thickness of the adhesive layer is preferably less than 5 mils (125 microns) and more preferably less than 2 mils (50 microns). Although the adhesive layer is generally provided on the entire surface beneath the ink-receptive layer, if desired the adhesive may be provided only beneath the portions to be printed.

The adhesive may be applied directly to the retroreflective layer with any suitable coating technique including screen printing, spraying, ink jetting, extrusion-die coating, flexographic printing, offset printing, gravure coating, knife coating, brushing, curtain coating, wire-wound rod coating, bar coating and the like, as well as with various techniques that provide a foamed adhesive layer. The adhesive is typically provided as a substantially continuous layer beneath the ink-receptive layer at least beneath the portions to be printed. Alternatively, the adhesive may be coated onto a release liner and transfer coated onto the retroreflective layer. Further yet, the ink-receptive layer may first be applied to a web carrier, at least partially dried in the case of water-based and solvent-based adhesives, followed by the adhesive being applied to the ink-receptive layer and then transfer coated in tandem to the retroreflective layer. For water-based and solvent-based coatings, the coating (i.e. ink-receptive top coat and/or adhesive) is sufficiently dried after being coated. Sufficient drying may be achieved by air-drying at room temperature for at least 24 hours. Alternatively the coating(s) may be dried in a heated oven ranging in temperature from about 40° C. to about 70° C. for about 5 to about 20 minutes followed by room temperature drying for about 1 to 3 hours.

The imaged retroreflective articles are preferably “durable for outdoor usage” meaning that the article can withstand temperature extremes, exposure to moisture ranging from dew to rainstorms, and colorfast stability under sunlight's ultraviolet radiation. In the case of signage for traffic control, the articles of the present invention are preferably sufficiently durable such that the articles are able to withstand at least one year and more preferably at least three years of weathering. This can be determined with ASTM D4956-99 Standard Specification of Retroreflective Sheeting for Traffic Control that describes the application-dependent minimum performance requirements, both initially and following accelerated outdoor weathering, of several types of retroreflective sheeting. The coefficient of retroreflection values, both initially and following outdoor weathering, are typically about 50% lower on imaged retroreflective substrates.

To enhance durability of the imaged substrate, especially in outdoor environments exposed to sunlight, a variety of commercially available stabilizing chemicals such as heat stabilizers, UV light stabilizers, and free-radical scavengers are typically included in the ink-receptive layer.

The article is suitable for use as traffic signage, roll-up signs, flags, banners and other articles including other traffic warning items such as roll-up sheeting, cone wrap sheeting, post wrap sheeting, barrel wrap sheeting, license plate sheeting, barricade sheeting and sign sheeting; vehicle markings and segmented vehicle markings; pavement marking tapes and sheeting; as well as retroreflective tapes. The article is also useful in a wide variety of retroreflective safety devices including articles of clothing, construction work zone vests, life jackets, rainwear, logos, patches, promotional items, luggage, briefcases, book bags, backpacks, rafts, canes, umbrellas, animal collars, truck markings, trailer covers and curtains, etc.

Retroreflective commercial graphic films include a variety of advertising, promotional, and corporate identity imaged films. The films typically comprise a pressure sensitive adhesive on the non-viewing surface in order that the films can be adhered to a target surface such as an automobile, truck, airplane, billboard, building, awning, window, floor, etc. Alternatively, imaged films lacking an adhesive are suitable for use as a banner, etc. that may be mechanically attached to building, for example, in order to display.

Objects and advantages of the invention are further illustrated by the following examples, but the particular materials and amounts thereof recited in the examples, as well as other conditions and details, should not be construed to unduly limit the invention.

### Test Method—Elastic Modulus

The elastic modulus of the ink-receptive layer and adhesive layer employed in the examples was determined with the following test method:

A sample, having dimensions no greater than 1″×1″ by ½ inches in thickness, was mounted on a 2 inch diameter aluminum cylinder which serves as a fixture in the Nanoindenter XP (MTS Systems Corp. Nano Instruments Division, Oak Ridge, Tenn.). For all experiments a diamond Berkovich probe (also available from MTS Systems Corp.) was used. The nominal loading rate was set at 10 nm/s with spatial drift setpoint set at 0.05 nm/s maximum. A constant strain rate experiment at 0.05/s to a depth of 200 nm was used. The layer to be characterized was located as seen top-down as viewed through a video screen with 100× magnification. The test regions were selected locally with 100× video magnification of the XP to insure that tested regions are representative of the desired sample material, i.e. free of voids, inclusions, or debris. Furthermore, microscope optical axis-to-indenter axis alignment is checked and calibrated previous to testing by an iterative process where test indentations are made into a fused quartz standard, with error correction provided by software in the XP.

The sample surface is located via a surface find function where the probe approaches the surface with a spring stiffness in air which changes significantly when the surface is encountered. Once the surface is encountered, load-displacement data is acquired as the probe indents the surface. This data is then transformed to Hardness and Elastic Modulus material properties based on the methodology described below. The experiment is repeated in different areas of the sample so that a statistical assessment can be made of the mechanical properties.

The Elastic Modulus determined directly from the load-displacement data is a composite Modulus, i.e. the Modulus of the XP Indenter Tester-to-sample mechanical system. The composite Modulus for these load-displacement indentation experiments can be determined from:

S=2/SQRT(Pi)*F*SQRT(A)

where

S—contact stiffness, determined via the MTS XP's patented Continuos-Stiffness-Method, by solving the differential equation relating a periodic forcing function F(t,w)=m d\hat{ }2x/dt\hat{ }2+k x+b dx/dt to the coefficients of the rheological sample-indenter mechanical system, i.e. the in-phase and out-of-phase components of the displacement response to the forcing function, yield the in-phase spring constant K, (thus the stiffness—hence contact area), and out of phase damping coefficient, b. The default excitation frequency for these tests is 45 hz;

A—area of contact [m\hat{ }2], assuming that the indentation replicates the shape of the indenter during indentation, the indenter geometry is modeled via analytic geometry so that the projected area, A=h\hat{ }2+higher order terms where h—displacement depth, and higher order terms are empirically measured;

F—Composite Modulus [GPa]

Then the sample material's Elastic Modulus (E) is obtained from:

1/F=(1−u\hat{ }2)/K+(1−v\hat{ }2)/E

where

u—Poisson Ratio of diamond indenter=0.07

K—Elastic Modulus of diamond indenter=1141 GPa

v—Poisson Ratio of samples

A Poisson's Ratio of 0.4 is assumed for these polymeric specimens, while 0.18 for the calibration standard is entered into the algorithm for determining Elastic Modulus.

Preparation of Image-Receptive Layer Coating Solution

A 15 gram mixture of 11.4 parts of ethanol alcohol, 3.5 parts of crosslinker (“CX 100”), and 0.1 part surfactant commercially available from Air Product & Chemical Inc., Allentown, Pa. under the trade designation “Surfylnol 104PA” was added to a 85 gram mixture of 68 parts of a aliphatic polyurethane dispersion (“Neorez R-960”) and 17 parts of distilled water and mixed for 10 minutes using a conventional air mixer at a slow speed.

Coating the Image Receptive Top Coat Layer on a Web Carrier

The solution was coated onto a 0.002 inch thick polyester carrier web using a wire bar (US#8 from R.D. Specialties). The coating was dried in a dryer oven at 66° C. for 1-2 minutes to dry off the solvents to yield a 0.00005-0.0001 inch thick crosslinked urethane ink-receptive layer. This dried ink-receptive layer was determined to have an elastic modulus of 2.16 GPa.

### EXAMPLE 1

The ink-receptive layer prepared on a polyester web carrier, as previously described, was laminated to retroreflective sheeting commercially available from 3M under the trade designation “3M Scotchlite Retroreflective Sheeting Series 3750” using a pressure sensitive adhesive having the formulation of 93/7 IOA/AA (i.e. iso-butyl acrylate/acrylic acid) at a thickness of 0.002 inch having an elastic modulus of 0.01 GPa. The lamination conditions were:

Nip roll pressure=40 PSI

Temperature=24° C.

Speed=1.5 meter/min

The resulting sheeting had the polyester web carrier on the top exposed surface of the sheeting, the ink receptive layer beneath the web carrier, the pressure sensitive adhesive layer beneath the ink-receptive layer, and the retroreflective base sheeting beneath the adhesive layer. The polyester web carrier was removed upon printing.

### EXAMPLE 2

Example 2 was prepared in the same manner as Example 1, except that the pressure sensitive adhesive composition comprised of 97/3 IOA/AA with 38% of a tackifier commercially available from Hercules Inc., Wilmington, Del. under the trade designation “Foral 85”, the adhesive having an elastic modulus of 0.023 GPa.

### EXAMPLE 3

Example 3 was prepared in the same manner as Example 1, except that the pressure sensitive adhesive composition comprised 87/13 IOA/AA, having an elastic modulus of 0.025 GPa.

### EXAMPLE 4

Example 4 was prepared in the same manner as Example 1, except that the ink-receptive coating was replaced with a 0.002 inch (0.051 mm) acrylic-based film, commercially available from Polymer Extruded Products, Inc., Newark, N.J. under the trade designation “Korad 05005”. The elastic modulus of this film was determined to be 0.86 GPa, according to the test method previously described.

### Comparative EXAMPLE A

Comparative Example A was prepared in the same manner as Example 1, except that the ink-receptive topcoat solution was coated directly onto the sheeting. Thus, no adhesive was present between the retroreflective sheeting layer and the ink-receptive topcoat.

### Comparative EXAMPLE B

Comparative Example B was prepared in the same manner as Comparative Example A except the retroreflective sheeting employed was sheeting commercially available from 3M under the trade designation “Scotchlite Retroreflective Sheeting, Series 4770”. This sheeting has an extruded ethylene-acrylic acid copolymer ink-receptive layer having an elastic modulus of 0.58 GPa.

Examples 1-4 and Comparative Examples A-B were printed with a thermal mass printer, commercially available from Zebra Technologies Corp., Vernon Hills Ill. under the trade designation “L170XI” using two different thermal mass transfer resin ribbons, namely a sapphire blue ribbon commercially available from IIMAK under the trade designation “DC300” and a black ribbon commercially available from Dai Nippon under the trade designation “R-510” which uses a harder resin.

All examples and comparative example were run through the printer at a web speed of 2 inches/second (5 cm/sec), medium print head pressure, and various print head temperature settings, as set forth in the test results. Printing was done separately with each of the ribbons. For those examples and comparative examples having the top PET web carrier, the PET carrier was removed prior to printing.

After printing, the print quality of the imaged sheeting was visually accessed. Test patterns included filled block, big and small alphanumeric characters, and cross-web bar codes. The pieces were held at arm's length and subjectively rated according to the criteria set out in Table 1.

TABLE 1

| Print Quality | |
|---|---|
| Rating (PQR) | Description of the Rating |
| 1 | Very Poor - less than 10% print coverage missing small and large |
| | characters; incomplete non readable bar codes; block area |
| | incomplete; no usable data was printed |
| 2 | Poor - less than 50% print coverage; missing small characters; some |
| | large characters printed; bar codes almost complete, but not |
| | readable; block area spotty; some useful data printed |
| 3 | Average - about 90% print coverage, but with some wrinkles, voids |
| | and spotting; small characters mostly printed; large characters all |
| | printed; bar code thin lines may be incomplete, but mostly readable; |
| | block area with larger pin holes and wrinkle lines; data readable other |
| | than some small characters |
| 4 | Good - about 99% print coverage with minor spotting; all print good |
| | other than small pin holes and some minor leading or trailing edge poor |
| | definition; all data readable |
| 5 | Very Good - about 99.9% print coverage with crisp, clean, dark |
| | print that was complete and very readable |

The test results were as follows:

TABLE 2

| | | | PQR with |
|---|---|---|---|
| | Print head | PQR with | DC300 |
| | Temperature | Black R510 | Sapphire |
| Examples | Setting | Ribbon | Blue |
| Example 1 | Medium, 25 | 5 | 5 |
| Example 1 | Low, 23 | 3 | 4 |
| Example 2 | Medium, 25 | 5 | 5 |
| Example 2 | Low, 23 | 3 | 4 |
| Example 3 | Medium, 25 | 5 | 5 |
| Example 3 | Low, 25 | 3 | 4 |
| Example 4 | Medium, 25 | 5 | 5 |
| Example 4 | Low, 23 | 5 | 5 |
| Comparative A | Medium, 25 | 2 | 2 |
| Comparative A | Low, 23 | 1 | 1 |
| Comparative B | Medium, 25 | 2 | 2 |
| Comparative B | Low, 23 | 1 | 1 |

Example 1and Comparative Examples A-B were also test printed on a thermal mass transfer printer generally illustrated in FIG. 4 of U.S. Pat. No. 6,246,428 B1, using the “DC300” ribbon. The printing was done at the same web speed of 7.62 centimeters/sec. (3 inches/sec.), print head pressure, and low print head temperature. The results are in Table 3 as follows:

TABLE 3

| | Print head | |
|---|---|---|
| | Temperature | |
| Examples | Setting | PQR |
| Example 1 | Low | 5 |
| Comparative A | Low | 2 |
| Comparative B | Low | 2 |

In each of the example the print quality was improved by the presence of the adhesive layer between the ink-receptive layer and the retroreflective sheeting layer.

What is claimed is:

1. A method of printing a retroreflective substrate comprising:
a) providing a substrate comprising:
i) a retroreflective layer;
ii) an adhesive layer disposed on the retroreflective layer; and
iii) an ink-receptive layer disposed on the adhesive layer wherein the ink-receptive layer has a thickness of less than 1 mil; and
b) printing the ink-receptive layer.

2. The method of claim 1, wherein the print quality is improved by at least one integer according to the Print Quality Rating Scale.

3. The method of claim 1, wherein the print quality is improved by at least two integers according to the Print Quality Rating Scale.

4. The method of claim 1, wherein the printing includes contact between the substrate and a printing device.

5. The method of claim 4 wherein the printing is accomplished by means of thermal mass transfer printing.

6. The method of claim 1 wherein the ink-receptive layer has a thickness of less than 0.8 mils.

7. The method of claim 1 wherein the ink-receptive layer has a thickness of less than 0.5 mils.

8. The method of claim 1 wherein the ink-receptive layer has a thickness of less than 0.3 mils.

9. The method of claim 1 wherein the adhesive permanently bonds the retroreflective layer to the ink-receptive layer.

10. The method of claim 1 wherein the adhesive has a elastic modulus of less than 0.3 GPa.

11. The method of claim 1 wherein the adhesive has a elastic modulus of less than 0.2 GPa.

12. The method of claim 1 wherein the adhesive has a elastic modulus of less than 0.1 GPa.

13. The method of claim 1 wherein the ink-receptive layer comprises a vinyl-based polymer, a polyurethane polymer, an acrylic polymer, or mixture thereof.

14. The method of claim 1 wherein the retroreflective layer comprises a plurality of cube corner retroreflective elements.

15. The method of claim 1 wherein the retroreflective layer comprises a binder layer having glass microspheres.

16. A method of printing a retroreflective substrate comprising:
a) providing a substrate comprising:
i) a retroreflective layer comprising a first major surface and second major surface;
ii) an adhesive layer disposed above the first major surface layer of the retroreflective layer; and
iii) an ink-receptive layer disposed above the adhesive layer; and
b) printing the ink-receptive layer;
wherein the print quality is improved by at least one integer according to the Print Quality Rating Scale.

17. An imaged retroreflective article comprising:
a) sheeting comprising:
i) a retroreflective layer;
ii) an adhesive layer disposed on the retroreflective layer; and
iii) an ink-receptive layer disposed on the adhesive layer, wherein the ink-receptive layer has a thickness of less than 1 mil; and
b) a printed image on the ink-receptive layer.

18. Thermal mass printable retroreflective sheeting comprising:
a) a retroreflective layer comprising a first major surface and second major surface;
b) an adhesive layer disposed on the first major surface layer of the retroreflective layer; and
c) an ink-receptive layer disposed on the adhesive layer;
wherein the ink-receptive layer has a thickness of less than 1 mil.

19. The sheeting of claim 18 wherein the ink-receptive layer has a thickness of less than 0.8 mils.

20. The sheeting of claim 18 wherein the ink-receptive layer has a thickness of less than 0.5 mils.

21. The sheeting of claim 18 wherein the ink-receptive layer has a thickness of less than 0.3 mils.

22. The sheeting of claim 18 wherein the adhesive permanently bonds the retroreflective layer to the ink-receptive layer.

23. The sheeting of claim 18 wherein the adhesive has a elastic modulus of less than 0.3 GPa.

24. The sheeting of claim 18 wherein the adhesive has a elastic modulus of less than 0.2 GPa.

25. The sheeting of claim 18 wherein the adhesive has a elastic modulus of less than 0.1 GPa.

26. The sheeting of claim 18 wherein the ink-receptive layer comprises a vinyl-based polymer, a polyurethane polymer, acrylic polymer, or mixture thereof.

27. The sheeting of claim 18 wherein the retroreflective layer comprises a plurality of cube corner retroreflective elements.

28. The sheeting of claim 18 wherein the retroreflective layer comprises a binder layer having glass microspheres.

29. A method of printing a retroreflective substrate comprising:
a) providing a substrate comprising:
i) a retroreflective layer;
ii) an adhesive layer disposed on the retroreflective layer; and
iii) an ink-receptive layer disposed on the adhesive layer wherein the ink-receptive layer comprises an acrylic-based polymer or urethane-based polymer; and
b) printing the ink-receptive layer.

30. An imaged retroreflective article comprising:
a) sheeting comprising:
i) a retroreflective layer;
ii) an adhesive layer disposed on the retroreflective layer; and
iii) an ink-receptive layer disposed on the adhesive layer, wherein the ink-receptive layer comprises an acrylic-based polymer or urethane-based polymer; and
b) a printed image on the ink-receptive layer.

31. Thermal mass printable retroreflective sheeting comprising:
a) a retroreflective layer comprising a first major surface and second major surface;
b) an adhesive layer disposed on the first major surface layer of the retroreflective layer; and
c) an ink-receptive layer disposed on the adhesive layer;
wherein the ink-receptive layer comprises an acrylic-based polymer or urethane-based polymer.
